(19) United States
(12) Patent Application Publication
(10) Pub. No.: US 2011/0005512 A1
(43) Pub. Date: Jan. 13, 2011

(54) ADJUSTABLE SOLAR PANEL SUPPORT STRUCTURE

(76) Inventor: Scott RUESSWICK, Canterbury, NH (US)

Correspondence Address: DAVIS & BUJOLD, P.L.L.C., 112 PLEASANT STREET, CONCORD, NH, 03301, US

(21) Appl. No.: 12/501,004

(22) Filed: Jul. 10, 2009

(51) Int. Cl. F24J 2/04; B23P 11/00

(52) U.S. Cl. 126/600; 29/428

(57) ABSTRACT

A solar panel mount comprising an end cap which supports the solar panel on a support structure. A support frame is pivotably supported by the end cap and the support frame has a plurality of cross members secured to a top surface thereof. A plurality of transverse members are secured to a top surface of the plurality of cross members and the plurality of transverse members are adjustable along a length of the cross members to accommodate different size solar panels. Each traverse member generally comprises an elongate inverted T-shaped base member and mating clamp member which is attached thereto by at least one fastener.

### FIELD OF THE INVENTION

The present invention relates to improvements concerning solar panel mounting structures which facilitate mounting of various sized solar panels to the same solar panel mount in a convenient fashion.

### BACKGROUND OF THE INVENTION

A variety of different support structures are currently available for mounting various solar panels to a support structure, such as a roof, and such prior art mounting structures work reasonable well when mounting identical or similar size solar panels to the same support structure. However, a variety of problems are encountered when attempting to mount different size solar panels on the same support structure. That is, it is difficult to securely attach each one of the different size solar panels to a single support structure so that the solar panels can operate efficiently while, at the same time, still being able to withstand the elements of nature, such as wind, snow, rain, etc.

### SUMMARY OF THE INVENTION

Wherefore, it is an object of the present invention to overcome the above mentioned shortcomings and drawbacks associated with the prior art.

Another object of the present invention is to provide a solar panel mount which can be oriented in a substantially horizontal orientation, to facilitate mounting and installation of the solar panels thereto, while allowing easy adjustment of the transverse members, relative to the cross members, to facilitate accommodating a variety of different sized PV solar panels on a single solar panel mount.

A further object of the present invention is to provide a solar panel mount which can be readily customized to accommodate more or less solar panels as well as accommodate solar panels having different sizes merely by adjustment of the mounting components of the solar panel mount.

Yet another object of the present invention is to provide a solar panel mount which has a pair of opposed side trim members which assist with facilitating permanent retention of the PV solar panels, on the solar panel mount, while also providing the sides of the solar panel mount with an ascetically pleasing appearance.

A still further object of the present invention is to provide a solar panel mount which can be easily rotated 360 degrees, relatively to a support structure or pole, as well as facilitate relatively easy tilting or pivoting the solar panel mount, from a horizontal orientation to a 65 degree or so orientation and vice versa, to ensure that all of the supported PV solar panels of the solar panel mount are precisely aligned substantially perpendicular with the sun's rays so that each PV solar panel may receive an optimum amount of solar energy from the sun to maximize generation of electrical energy.

Still another object of the invention is to provide a solar panel mount that can be mounted on a pole, or some other support structure, which provides added versatility to the solar panel mount.

The present invention also relates to a solar panel mount comprising: an end cap for supporting the solar panel mount, in a rotational manner, on a support; a support frame being pivotably supported by the end cap about a pivot axis; a plurality of cross members being secured to a top surface of the support frame; and a plurality of transverse members being secured to a top surface of the plurality of cross members, and the plurality of transverse members being adjustable along a length of the cross members to accommodate different size solar panels between adjacent ones of the plurality of transverse members.

The present invention also relates to a method of providing a solar panel mount which can be adjusted to a desired solar energy collecting orientation, the method comprising the steps of: providing the solar panel mount with an end cap for supporting the solar panel mount in a rotatable manner on a support; pivotably supporting a support frame to the end cap in which the support frame is able to pivot about a pivot axis; securing a plurality of cross members to a top surface of the support frame; and securing a plurality of transverse members to a top surface of the plurality of cross members, and permitting the plurality of transverse members to be adjustable along a length of the cross members to accommodate different size solar panels between adjacent ones of the plurality of transverse members.

### BRIEF DESCRIPTION OF THE DRAWINGS

The invention will now be described, by way of example, with reference to the accompanying drawings in which:

FIG. 1 is a diagrammatic perspective view of a support frame with a solar panel mount showing both the horizontal and a tilted orientation;

FIG. 1A is a diagrammatic perspective view of the end cap;

FIG. 2 is a elevational side view of the support frame of the solar panel mount shown in the horizontal position;

FIG. 3 is a diagrammatic view of the solar panel mount of FIG. 2 along section line 3-3;

FIG. 4 is a top perspective view of the solar panel mount according to the present invention;

FIG. 5 is a diagrammatic view showing attachment of the cross members of the support frame;

FIG. 5A is a diagrammatic cross sectional view showing attachment of the cross members of the support frame;

FIG. 6 is a diagrammatic perspective view showing the attachment of the transverse members to the cross members;

FIG. 6A is a diagrammatic perspective view showing an alternative embodiment of the transverse member; and

FIG. 7 is a diagrammatic transverse cross sectional view showing attachment of the transverse members for sandwiching a PV solar panel therebetween.

### DETAILED DESCRIPTION OF THE INVENTION

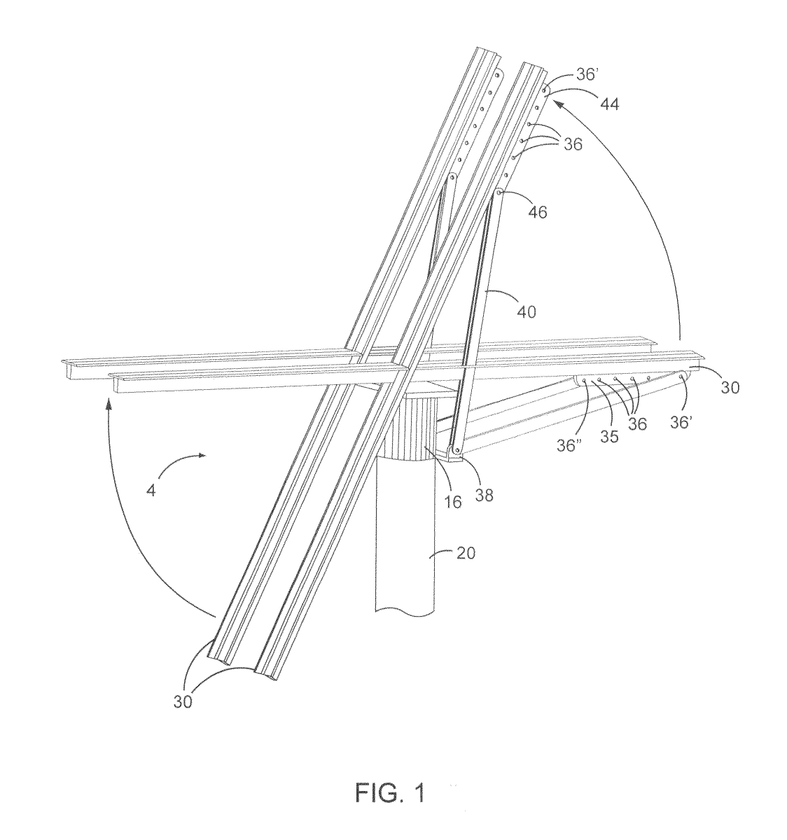

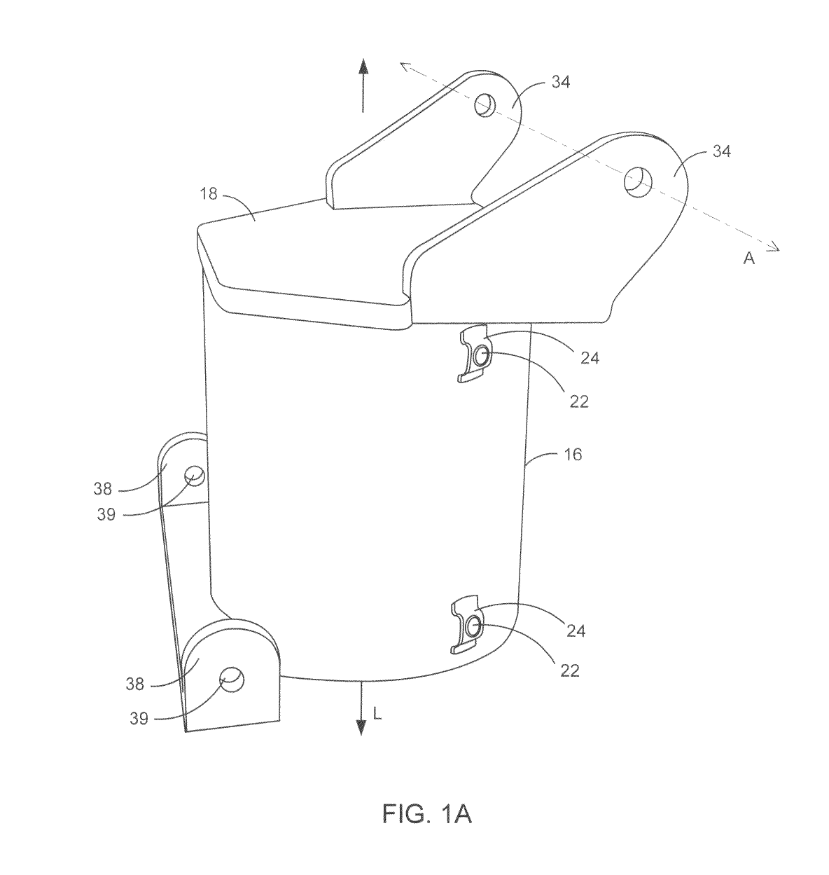

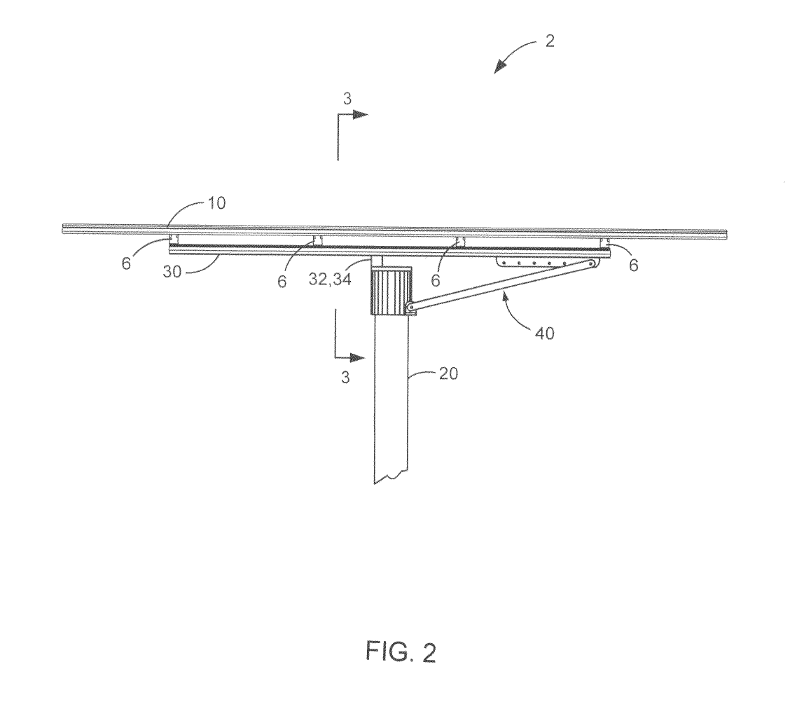

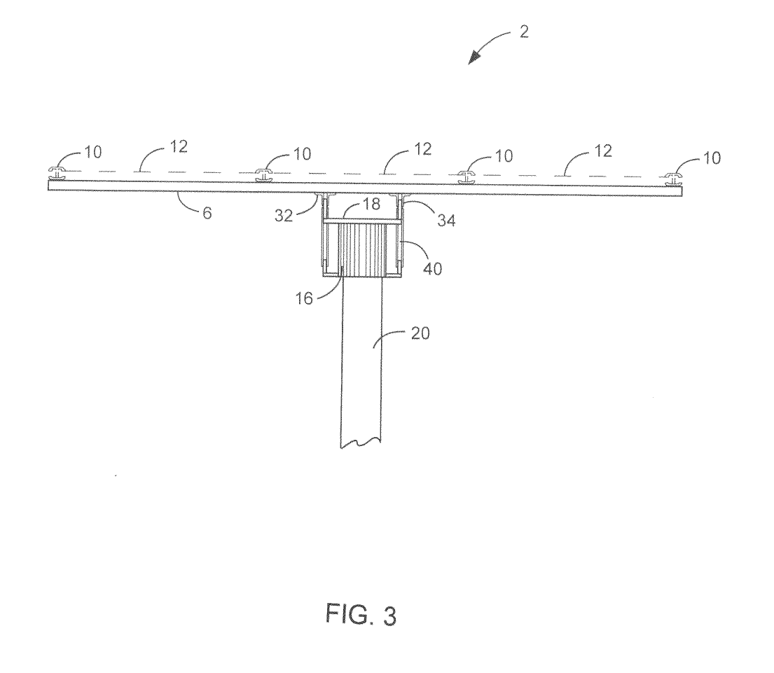

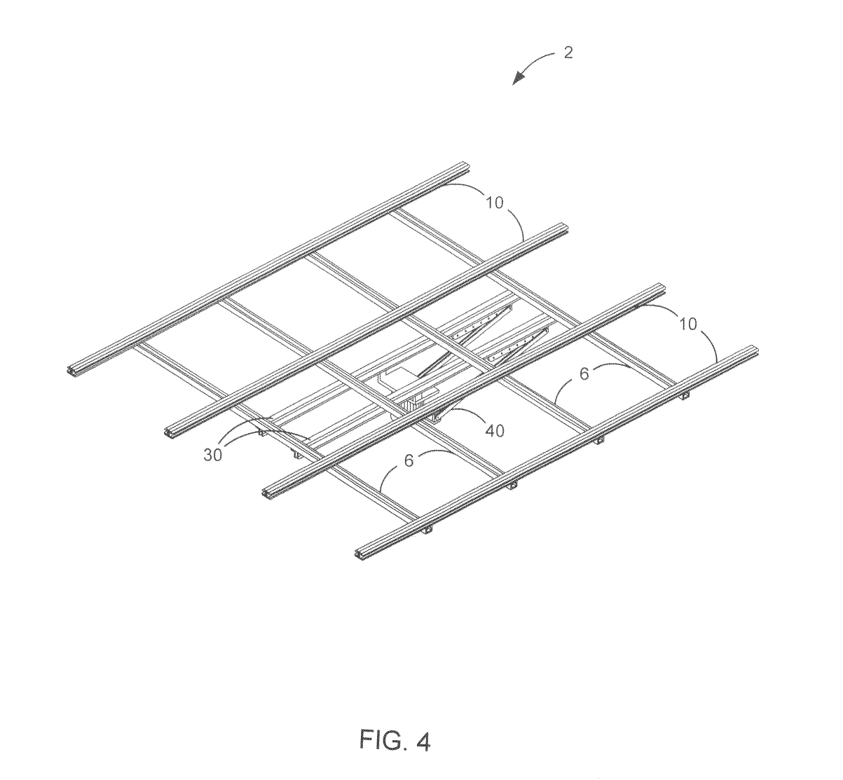

Turning now to FIGS. 1-4, a brief description concerning the various components of the solar panel mount 2, according to the present invention, will now be discussed. As can be seen in these Figures, the solar panel mount 2 generally comprises a support frame 4 which carries a plurality of cross members 6, e.g., typically four (4) cross members 6 as shown in FIGS. 2 and 4, which are fixedly secured to the top surfaces 8 of the support frame 4. In addition, typically between two (2) and five (5) transverse members 10, e.g., four (4) transverse members 10 as also shown in FIGS. 3 and 4, are adjustably attached to top surfaces 9 of the cross members 6, and the PV solar panels 12 (not shown in detail) are secured to the transverse members 10, and a further detailed description concerning such adjustable attachment and securement of the PV solar panels 12 to the solar panel mount 2 will be provided below.

With reference to FIGS. 1 and 1A, to facilitate mounting of the solar panel mount 2 to the support frame 4, a lower surface 14 of the support frame 4 generally comprises a cylindrical end cap 16 which defines an internal cavity therein that is closed by an end plate or wall 18. The end wall 18 forms a stop for the end cap 16 which prevents further insertion of a leading end of a support structure or pole 20, or some other support structure for the solar panel mount 2, into the cavity of the end cap 16. The end cap 16 normally has a length of between 8 and 10 inches and an internal diameter of a standard pipe size, e.g., between 3 and 12 inches and more preferably a diameter of about 6 to 8 inches. The end cap 16 is typically manufactured from a durable metal such as steel and the side wall of the end cap 16 has a thickness of between about ⅛ and ½ inches and more preferably a thickness of about ¼ inches. The end cap 16 defines a longitudinal axis L which is coincident with a longitudinal axis of the pole 20.

The end cap 16 is provided with at least one conventional alignment feature or element for maintaining the end cap 16 in a desired orientation relative to the pole 20 once installed thereon. That is, although the end cap 16 generally should be able to spin or rotate 360 degrees, relative to the pole 20, in order to adjust or rotate the solar panel mount 2 to a desired solar energy collecting position, the end cap 16 should also be able to retain the solar panel mount 2 in the desired adjusted solar energy collecting orientation. In order to achieve this, a sidewall of the end cap 16 is provided with a plurality of threaded apertures 22, or some other conventional securing feature 22, about the circumference of the end cap 16. A set screw 24 threadedly engages with each one of the threaded apertures 22 so that as each set screw 24 is threaded into the associated threaded aperture 22, a leading end thereof is driven into the pole 20 to secure the end cap 16 to the pole 20 and prevent rotation of the solar panel mount 2 relative to the pole 20. It is to be appreciated that the larger the size of the solar panel mount 2, generally the greater the diameter of the threaded apertures 22 and the associated set screws 24 and/or the greater the number of the threaded apertures 22 and the associated set screws 24 normally required to facilitate secure retention of the solar panel mount 2, relative to the pole 20, in a desired solar energy collecting position.

An intermediate section of an under or bottom surface 28 of a pair of adjustable support beams 30 carries or has attached thereto a first portion of a hinge 32 (shown in FIGS. 2 and 3) which is coupled to a mating second portion of a mating hinge 34 supported by or integrally formed with a top surface or an end wall of the end cap 16. A pivot pin 33 couples the first and the second portions of the mating hinge 32, 34 with one another to form a solar panel mount pivot axis A which facilitates pivoting movement of the pair of adjustable support beams 30 relative to the end cap 16, via the first and the second portions of the hinge 32, 34, and a further detail discussion concerning the purpose of the same is provided below.

A plate 35 is secured adjacent a first end of each of each of the pair of adjustable support beams 30 and the plate 35 has a plurality of spaced apart and sequentially arranged adjustment apertures 36′, 36″ formed therein. A lower most, bottom area or edge of the end cap 16 carries, or has integrally formed therewith, a first portion of a pair of protruding pivot supports 38. A first end of a fixed length adjustment arm 40 has a through bore therein which is aligned with a through bore 39, formed in a respective one of the protruding pivot supports 38, and pivotably secured thereto via a respective conventional removable fastener 42, such as a locking pin having a mating removable retaining clip, a mating nut/bolt/washer assembly, etc. An adjustment bore 44 is formed adjacent an opposite second end of each of the adjustment arms 40 and each of the adjustment bore 44 is likewise respectively alignable with a desired one of the plurality of adjustment apertures 36′, 36″, provided along the under or bottom surface of each of the pair of adjustable support beams 30, to facilitate retaining the pair of adjustable support beams 30 in a desired tilted orientation, relative to the end cap 16. A respective conventional removable fastener 46, such as a locking pin having a mating removable retaining clip, a mating nut/bolt/washer assembly, etc., retains the second end of each adjustment arm 40 in engagement with a desired one of the adjustment apertures 36′, 36″. Following alignment of the adjustment bore 44 with a selected one of the adjustment apertures 36, a leading end of the pin passes through the aligned apertures and bores 36, 44 and then the mating removable clip is affixed to either an annular groove or a hole formed in the leading end of the pin, for example, to prevent unintended withdrawal of the pin from the aligned apertures and bores 36′, 36″, 44.

When readjustment or realignment of a tilted orientation of the solar panel mount 2 about the solar panel mount pivot axis A is desired, the respective conventional removable fasteners 46 are removed, e.g., the mating removable clip is removed from the pin and the pin is then withdrawn from the aligned adjustment bore 44 and the selected one of the plurality of adjustment apertures 36′, 36″. Thereafter, the support frame 4, the cross members 6, the transverse members 10 and the PV panels 12 are all adjusted (e.g., tiled relative to the pole) in unison with one another, by an end user about the solar panel mount pivot axis A, to a desired solar energy collecting orientation. After this occurs, the adjustment bore 44 is again aligned with a selected one of the plurality of adjustment apertures 36′, 36″ to facilitate retaining the solar panel mount 2 in the desired solar energy collecting orientation. Next, the leading end of the pin passes through the aligned aperture and bore 36′, 36″, 44 and then the mating removable clip is affixed to the leading end of the pin to prevent unintended withdrawal of the pin from the aligned aperture and bore 36′, 36″, 44. If necessary or desired, the set screws 24 may be sufficiently loosened, relative to the associated threaded apertures 22, so that the end cap 16 can spin or rotate freely relative to the pole 20 thereby fine tuning the adjustment of the solar panel mount 2 in the desired solar energy collecting position. Once this occurs, the set screws 24 are then retightened to secure the solar panel mount 2 in the adjusted position.

As can be seen in FIG. 1, when the pair of adjustment arms 40 engage with the pair of outer most adjustment apertures 36′ of the adjustable support beams 30, the pair of adjustable support beams 30 are pivoted to and retained in a substantial horizontal orientation (as shown in light gray in FIG. 1) relative to the top surface or end wall 18 of the end cap 16. Such orientation of the solar panel mount 2 provides a generally flat, horizontal surface which assists with assembly and installation, at a desired installation site, of the PV solar panels 12 on the solar panel mount 2. However, when the pair of adjustment arms 40 are each secured to the radially inner most adjustment aperture 36″ (as shown in dark gray in FIG. 1), the pair of adjustable support beams 30 are pivoted or tilted into a substantially 65 degree orientation, or so, with respect to the top surface or end wall 18 of the end cap 16. The various other adjustment apertures 36, located between the pair of radially inner and outer most adjustment apertures 36″, 36′, facilitate adjusting the pair of adjustable support beams 30 in a variety of other tilted orientations between 0-65 degrees. It is to be appreciated that the number and/or spacing of the adjustment apertures 36, provided in under or bottom surface of the pair of adjustable support beams 30, can vary from application to application and depend upon the particular requirements of the installation site and the desired degree of adjustment to be achieved during tilting of the solar panel mount 2.

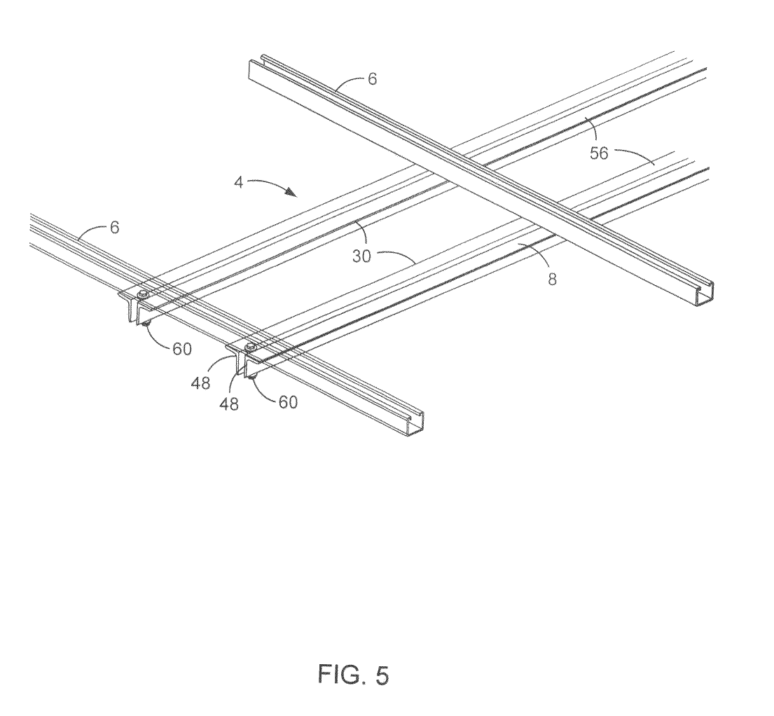

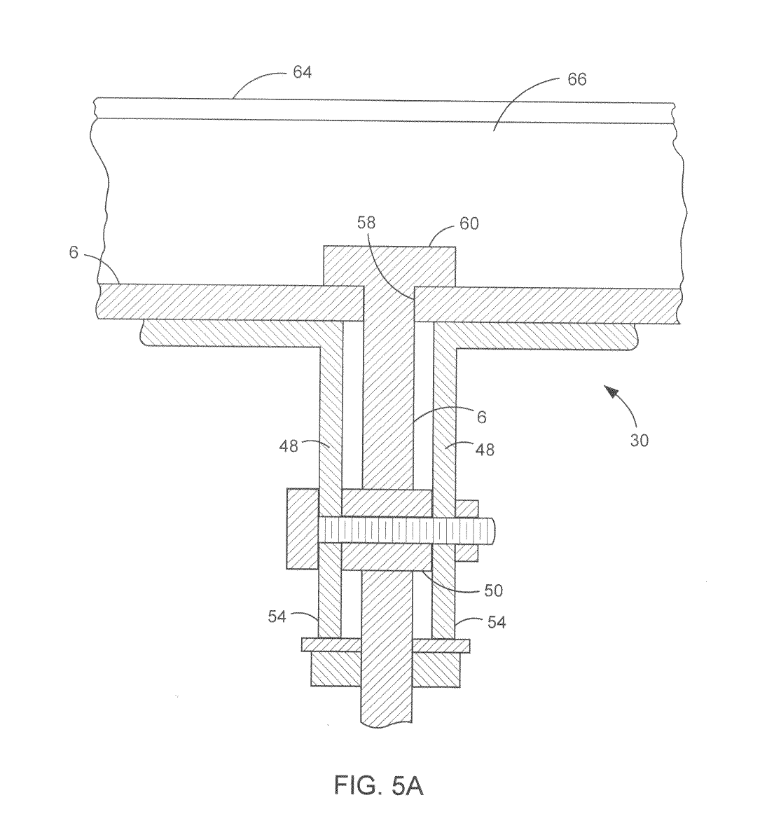

As shown in FIGS. 5 and 5A, each one of the pair of adjustable support beams 30 generally comprises a pair of L-shaped angle members 48 which are arranged, back-to-back with respect to one another, and are spaced apart from one another by a plurality of spaced apart spacers 50. A plurality of conventional threaded fasteners 52 each pass through a respective opening in the longer leg 54 of a first one of the L-shaped angle members 48, passes through one of the spacers 50 and then passes through another aligned opening in the other longer leg 54 of the second L-shaped angle member 48 and engages with a conventional nut to secure the pair of L-shaped angle members 48 to one another, back-to-back, and thereby form the ridged beam structure 30. The spacers 50 are suitable sized to provide a sufficient spacing or gap G between the mating surfaces of the longer legs 54 of first and the second L-shaped angle members 48 so that a threaded fastener, for the U-shaped cross members 6 (which will be described in further detail below), can readily pass through the gap G formed between the adjacent pair of L-shaped angle members 48, and facilitate securing of the U-shaped cross members 6 to the pair of adjustable support beams 30 by conventional fasteners. It is to be appreciated that the plate 35 is typically sandwiched between the longer leg 54 of the first and the second L-shaped angle members 48 and secured thereto by a threaded fastener so that the plate 35 also functions as the “spacer” to space the first and the second L-shaped angle members 48 away from one another.

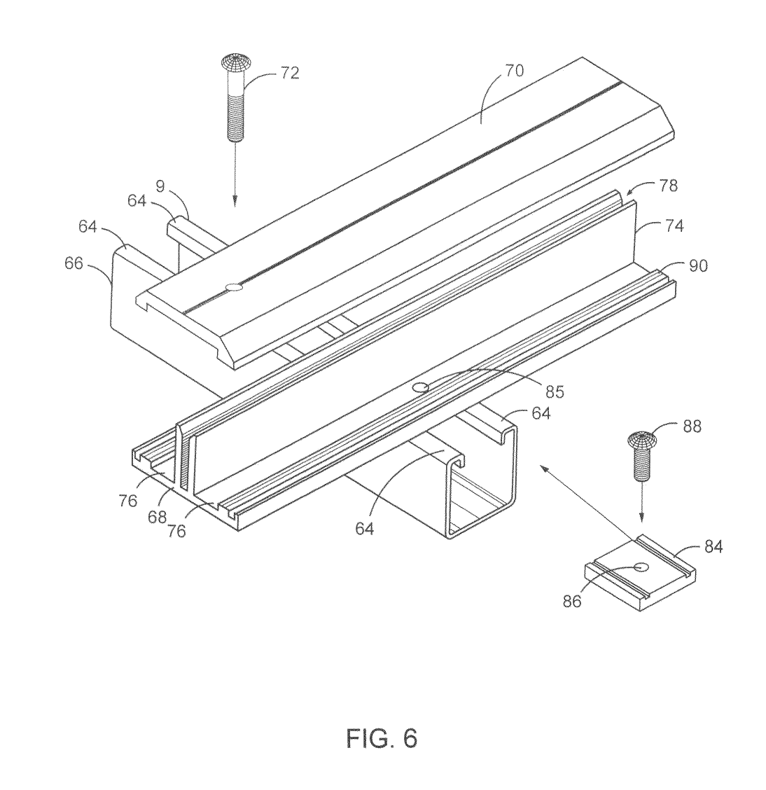

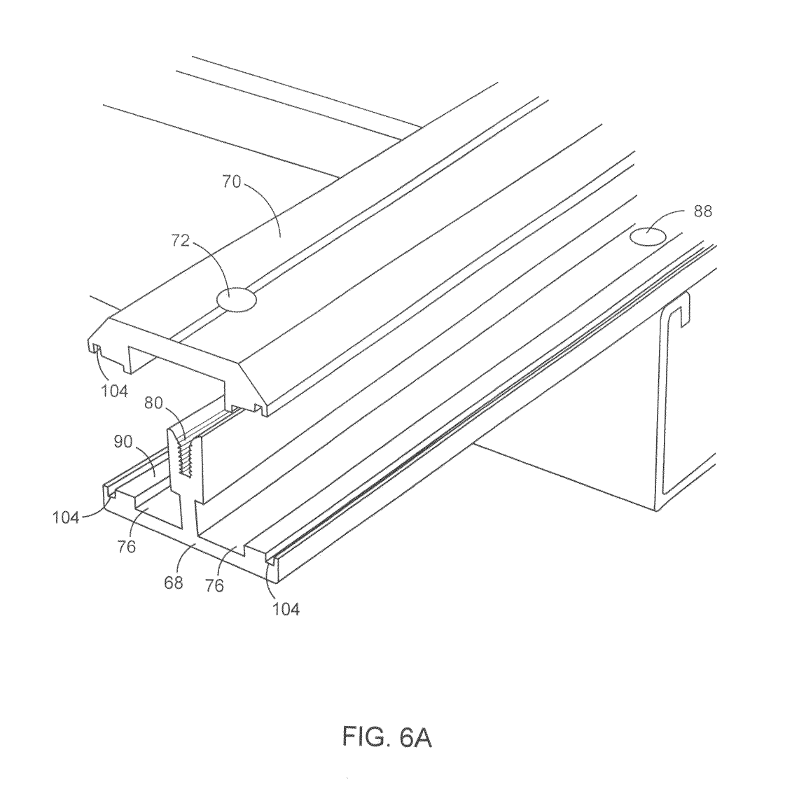

As can be seen in FIGS. 2 and 4, four U-shaped cross members 6 are each attached to a top surface 8 of the pair of adjustable support beams 30. Each cross member 6 is generally equally spaced from each adjacent cross members 6, e.g., the spacing between each adjacent cross members 6 typically ranges between 20 and 24 inches, for example. As can be seen in FIGS. 5, 5A and 6, each cross member 6 generally has a substantially U-shaped transverse cross section and at least two mounting holes 58 are formed in the base of each one of the cross members 6 to facilitate securing each cross member 6 to each of the pair of adjustable support beams 30. The at least two mounting holes 58 are generally spaced apart from one another by a distance of between 8 and 24 inches and preferably spaced apart from one another by a distance of about 12 inches. Each cross member 6 is securely fastened to each one of the pair of adjustable support beams 30 by a respective conventional fastener 60, such as a nut/bolt/washer assembly which passes through a mounting hole 58 in the base of the cross member 6 and extend through the gap G, formed between the pair of L-shaped angle members 48 which are arranged, back-to-back with respect to one another as discussed above. Thereafter, for example, a nut is attached to the leading end of the conventional fastener 60 to secure each cross member 6 to each one of the pair of adjustable support beams 30.

As can be seen in FIG. 6, for example, each one of the cross members 6 has an inwardly extending elongate flange 64, at an end of each leg 66 remote from a base of each U-shaped cross member 6, and the inwardly extending elongate flanges 64 facilitate attachment of the transverse members 10 to the cross members 6, and a further detailed discussion concerning the such attachment will follow.

Preferably each U-shape cross member 6 has a length between 16 and 200 inches or so and more preferably a length of about 130 inches. According to a preferred form of the invention, each of the cross members 6 initially has excess length and is normally cut to a desired length, as ordered by the customer, prior to shipment of the solar panel mount 2 or, alternatively, the cross members 6 are cut to a desired length at the installation site, prior to installation, to customize the overall width of the solar panel mount 2 during the installation process.

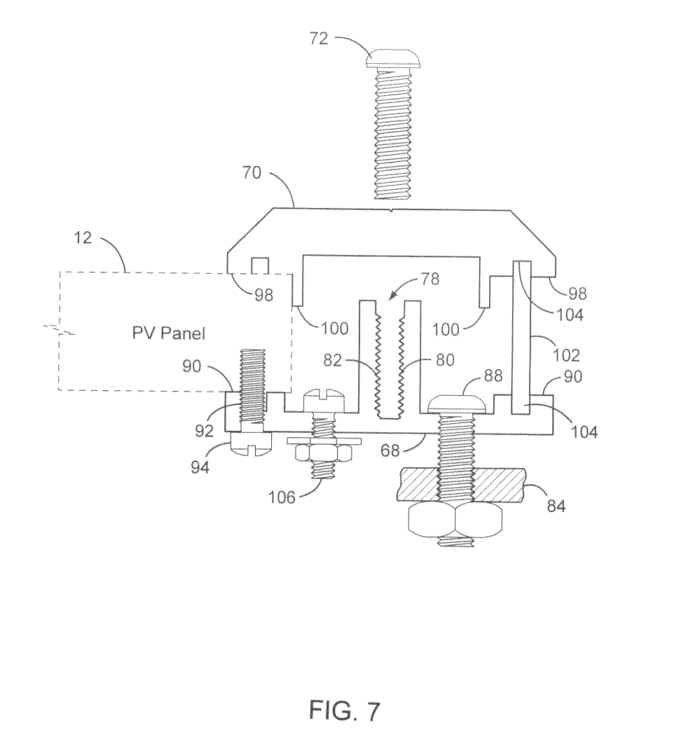

Generally between three and five, typically four transverse members 10, are supported by the top surfaces 9 of the cross members 6 in an abutting relationship with a top surface of each of the flanges 64 of the cross members 6. With reference to FIGS. 6, 6A and 7, detailed description concerning attachment of the transverse members 10 to the cross members 6 as well as the various features of the transverse members 10 will now be described.

As can be seen in these figures, each transverse member 10 generally comprises an elongate inverted T-shape base member 68 and a mating elongate clamp member 70. Each elongate base member 68 and clamp member 70 typically has a length of between 80 and 200 inches, and more preferably a length of about 120 inches or so. The mating base member 68 and clamp member 70 are designed to matingly engage with one another in a sandwiching configuration when affixed to one another by a plurality of spaced apart conventional threaded fasteners 72, such as threaded bolts or screws. The T-shape base member 68 generally comprises a central leg 74 and a pair of outwardly extending arms 76. An elongate slot 78 is formed within a remote portion of the central leg 74 and the elongate slot 78 extends along the entire length of the central leg 74. Each of the inwardly facing surfaces 80 of the elongate slot 78 of the central leg 74 has a portion of a thread 82 formed therein so that when a threaded fastener 72 passes through a hole formed within the clamp member 70 and engages, at any desired location along the elongate slot 78, with the threads 82 formed on the inwardly facing surfaces 80 of the slot, tightening of the threaded fasteners 72 gradually draws the clamp member 70 toward the base member 68 to facilitate clamping one or more desired PV solar panels 12 therebetween.

In order to facilitate attachment of each transverse member 10 to the cross members 6, a square mounting pad 84 is passed through one end of the U-shaped channel of the cross member 6 and positioned at a desired attachment located along the length of the cross member 6. Each mounting pad 84 has a centrally located threaded through bore 86 formed therein which matingly engages with a conventional fastener 88, which passes through a mounting hole 85 of the base member 68, to securely fasten the transverse member 10 to the cross members 6. Each mounting pad 84 also has a width dimension which is slightly less than the internal width dimension of the U-shaped channel but is larger than the spacing being the inwardly facing adjacent edges of the flanges 64, formed at the remote end of each leg 66 of the U-shaped channel, to prevent the mounting pad 84 from passing through the space located between the flanges 64. The conventional fastener 88 passes through the mounting hole 85, formed in the base member 68, and then threadedly engages with the threaded through bore 86, of the mounting pad 84, to secured the transverse member 10 to the cross member 6. Alternatively, the through bore 86 may not be threaded and the conventional threaded fastener passes through a mounting hole 85, formed in the base member 68, and then through bore 86, provided in the mounting pad 84, and thereafter the leading end of the conventional fastener 88 threadedly engages with a washer and a nut to secured the transverse member 10 to the cross member 6. As a result of this arrangement, tightening of the threaded fastener 88 sandwiches the flanges 64, of the U-shaped channel of the cross members 6, between the mounting pad 84 and the bottom or lower surface of the base member 68 into intimate frictional contact with one another to secure the transverse member 10 at a desired installed position relative to the cross member 6.

It is to be appreciated that each one of the transverse members 10 is normally attached to each one of the cross members 6 at one location, via the mounting pad 84. In addition, it is to be appreciated that the relative spacing between the transverse members 10 can be easily adjusted/reconfigured by merely sufficiently loosening the fastener 88, e.g., the threaded fastener or the nut and bolt assembly for example, sliding the transverse member 10 relative to the cross members 6 and thereafter retightening the threaded fastener(s) 88 to secure the transverse members 10 in the adjusted position relative to the cross members 6. Such adjustment features allows repositioning of the transverse members 10 so that they may readily accommodate different width, size and/or length PV solar panels 12.

Each one of the outwardly extending arms 76 generally has a flat angular surface 90 (see FIG. 7) which forms a support surface for a bottom surface of a PV solar panel 12, for example. In addition, a plurality of threaded holes 92 are formed along a length of each of the arms 76 to facilitate the securing the rear surface of the PV solar panel 12 thereto via a conventional fastener 94 passing through an aperture 96 provided in the arm 76 and threadedly engaging with a threaded hole (not shown in detail) formed in a rear surface of the PV solar panel 12 to securely attached PV solar panel 12 to the inverted T-shape base member 68. The clamp member 70 is also provided with a mating generally flat surface 98 which forms a mating support surface for a top surface of the PV solar panel 12 and facilitates clamping a top surface of the PV solar panel 12 to the clamp member 70. To prevent over insertion of the PV solar panel 12 into each transverse member 10, a pair of inner elongate stop lips 100 extend along the entire length of the clamp member 70.

As can be seen in FIG. 7, an elongate rectangular trim member 102 is provided in order to provide each opposed outwardly facing side surface of the solar panel mount 2 with an aesthetically pleasing finish or appearance. The trim member 102 generally has a length of between 80 and 200 inches, preferably about 120 inches, and a width of between 1 and 3 inches, preferably about 2 inches. It is to be appreciated that the overall width dimension of the trim member 102 ultimately depend upon the thickness of the PV solar panels 12 to be mounted to the solar panel mount 2.

To facilitate permanent retention of the trim member 102 by the base member 68 and the mating clamp member 70, each one of those members is provided with a elongate groove 104, which extends along the entire length of each of base member 68 and the mating clamp member 70. Each one of the mating grooves 104 is sized to captively receive and retain the trim member 102 therein, .e.g., the width of each groove is slightly larger than the thickness of the trim member 102. It is to be appreciated the overall dimension of the trim member 102 will be selected so that as the clamp member 70 is threaded towards the base member 68, the trim member 102 will maintain a top surface of the clamp member 70 in a substantially parallel orientation with respect to a bottom surface of the base member 68, and thereby ensure that the PV solar panel(s) 12 is/are securely fastened to the solar panel mount 2 without any excessive tilting of the clamp member 70 relative to the base member 68, which may possible damage the PV solar panel(s) 12 and/or provide an unsightly appearance. Accordingly, the trim member 102 will preferably have a larger width dimension, for thicker PV solar panels 12, and will have a smaller width dimension for thinner PV solar panels 12.

As can be seen in FIG. 7, the solar panel mount 2 is provided with at least one ground connection 106 which is used for grounding the entire the solar panel mount 2. As such ground connection 106 as well as grounding of a solar panel mount is conventional and well know in the art, a further detailed description concerning the same is not provided.

It is to be appreciated that the orientation of the solar panel 2 is generally changed at least twice a year, more preferably the orientation of the solar panel 2 is changed at least four or more times a year to compensate for the tilt of the earth relative to the sun.

Since certain changes may be made in the above described solar panel mount, without departing from the spirit and scope of the invention herein involved, it is intended that all of the subject matter of the above description or shown in the accompanying drawings shall be interpreted merely as examples illustrating the inventive concept herein and shall not be construed as limiting the invention.

Wherefore, I/we claim:

1. A solar panel mount comprising:
an end cap for supporting the solar panel mount, in a rotational manner, on a support;
a support frame being pivotably supported by the end cap about a pivot axis;
a plurality of cross members being secured to a top surface of the support frame; and
a plurality of transverse members being secured to a top surface of the plurality of cross members, and the plurality of transverse members being adjustable along a length of the cross members to accommodate different size solar panels between adjacent ones of the plurality of transverse members.

2. The solar panel mount according to claim 1, wherein the support frame comprises:
a pair of adjustable support beams having an intermediate section hingedly connected to the end cap while a remote end of each support beam has a plurality of adjustment apertures and an adjustment arm interconnects a desired one of the adjustment apertures with the end cap.

3. The solar panel mount according to claim 2, wherein a first end of the adjustment arm is pivotably attached to the end cap while a second end of the adjustment arm has an adjustment bore which is alignable with one of the adjustment apertures of the support beams.

4. The solar panel mount according to claim 3, wherein when the adjustment bore of the adjustment arm engages with an outermost adjustment aperture of the support beams, the support beams are pivoted and retained in a substantially horizontal arrangement which is substantially perpendicular to a longitudinal axis of the end cap and assists with assembly and installation of the solar panel mount, and when the alignment aperture of the adjustment arm engages with an innermost adjustment aperture of the support beams, the adjustable support beams are tilted to an orientation of about 65 degrees relative to the longitudinal axis of the end cap.

5. The solar panel mount according to claim 2, wherein each adjustable support beam generally comprises of a pair of L-shaped angle members which are arranged, back to back, with respect to one another and spaced apart by one another by a plurality of spacers which form a gap between the first and second L-shaped angle members.

6. The solar panel mount according to claim 1, wherein between three and five cross members are secured to the top surface of the support frame.

7. The solar panel mount according to claim 2, wherein each of the cross members comprises a U-shaped member having a bottom surface which is connected to the support beam by at least one fastener.

8. The solar panel mount according to claim 7, wherein each U-shaped member has at least two mounting holes formed in a base thereof to facilitate securing of the cross member to the support beams, and each one of the U-shaped cross members has a pair of inwardly extending flanges which extend along the entire length of the U-shaped cross member and extend toward one another.

9. The solar panel mount according to claim 8, wherein each U-shaped cross member has a length of 16 and 200 inches.

10. The solar panel mount according to claim 1, wherein each traverse member generally comprises an elongate inverted T-shaped base member and mating clamp member which is attached thereto by at least one fastener.

11. The solar panel mount according to claim 10, wherein the T-shaped base member generally comprises a central leg and a pair of outwardly extending arms, an elongate slot is formed within the central leg and extends along an entire length of the central leg with each inwardly facing surface of the elongate slot having a portion of a thread form thereon.

12. The solar panel mount according to claim 11, wherein each outwardly extending arm has a support surface for supporting a bottom surface of a solar panel and a plurality of holes are formed along a length of each outwardly extending arm to facilitate securing a rear surface of a solar panel thereto.

13. The solar panel mount according to claim 10, wherein the clamp member has generally flat surface which forms a mating support surface for a top surface of a solar panel to facilitate clamping of a top of the solar panel to the solar panel mount.

14. The solar panel mount according to claim 10, wherein each of the T-shaped base member and clamp member has a pair of elongate inner stop lips which extend along an entire length of the clamp member for preventing over insertion of a solar panel with respect to the T-shaped base members.

15. The solar panel mount according to claim 10, wherein the T-shaped base member is provided with an elongate groove, which extends along a length of the T-shaped base member and the mating clamp member is provided with an elongate groove, which extends along a length of the mating clamp member, and a trim member is accommodated within the mating grooves to assists with securing at least one solar panel to the solar panel mount such that opposed surfaces of the inverted T-shaped base member and the mating clamp member remain substantially parallel to one another.

16. The solar panel mount according to claim 1, wherein the solar panel mount is provided with at least one ground connection for grounding the solar panel mount.

17. The solar panel mount according to claim 1, wherein the end cap is generally cylindrical in shape and is provided with an alignment feature which facilitates maintaining the end cap in a desired position, relative to a support structure while permitting the end cap to rotate relative to the support structure.

18. The solar panel mount according to claim 18, wherein the alignment feature comprises at least one threaded aperture formed in the end cap at least one set screw engaging the at least one threaded aperture for maintaining the end cap in a desired orientation relative to the support structure.

19. A method of providing a solar panel mount which can be adjusted to a desired solar energy collecting orientation, the method comprising the steps of:
providing the solar panel mount with an end cap for supporting the solar panel mount in a rotatable manner on a support;
pivotably supporting a support frame to the end cap in which the support frame is able to pivot about a pivot axis;
securing a plurality of cross members to a top surface of the support frame; and
securing a plurality of transverse members to a top surface of the plurality of cross members, and permitting the plurality of transverse members to be adjustable along a length of the cross members to accommodate different size solar panels between adjacent ones of the plurality of transverse members.
